(19) United States
(12) Patent Application Publication
(10) Pub. No.: US 2017/0139904 A1
(43) Pub. Date: May 18, 2017

(54) SYSTEMS AND METHODS FOR CLOUD CAPTIONING DIGITAL CONTENT

(71) Applicants: COMCAST CABLE COMMUNICATIONS, LLC, Philadelphia, PA (US); NBCUNIVERSAL MEDIA, LLC, New York, NY (US)

(72) Inventors: Jon Dakss, Livingston, NJ (US); Ali Khorram, Philadelphia, PA (US); Fielding Kidd, New York, NY (US); Vladislav Plazinskiy, Staten Island, NY (US); Hai Xu, Kenvil, NJ (US); Michael Ibrahim, New York, NY (US)

(21) Appl. No.: 14/942,682

(22) Filed: Nov. 16, 2015

(51) Int. Cl. G06F 17/28

(52) U.S. Cl. CPC G06F 17/289

(57) ABSTRACT

In one embodiment, a method is provided. The method includes using a processor to receive identification information and a desired language. The identification information is utilized to uniquely identify a text file from a database, where the text file includes a first set of captions associated with digital content. The method includes using a processor to translate the first set of captions of the text file into the desired language utilizing a machine translation service and at least one human translator. The method includes using a processor to generate a translated text file comprising a second set of captions in the desired language and output the translated text file to a media viewing device for synchronous display with the digital content.

### BACKGROUND

The present disclosure relates generally to the field of digital content, and more particularly to techniques for a cloud-based system for creating, managing, and delivering universal language translations of closed captions for digital content.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Many existing media devices, such as televisions, are equipped with textual language features that facilitate comprehensible viewing access for a wide variety of people. For example, many media devices support multiple language features that facilitate presentation of subtitles in a selected language. Specifically, a television may enable a user to select a language in which to present subtitles for dialogue and/or onscreen text of a program, such as a movie or television show. As a further example, many media devices support closed captioning for hearing impaired viewers. Closed captioning provides an onscreen textual version of the audio for a program. For example, a textual version of dialogue and sound effects for a program may be presented on a television screen when a closed captioning option is active on the television.

An increasing area of interest in the field relates to delivering timed text (e.g., captions, subtitles, and other metadata) for digital content. Timed text generally relates to delivering text media synchronously with other forms of content, such as video or audio content. Timed text may be utilized in various applications, such as for providing subtitles for content accessed via the Internet, closed captioning for people with hearing impairments, scrolling news items, teleprompter applications, among others. Indeed, timed text features may be utilized for any type of digital content accessed from scheduled broadcasts or from “on demand” sources, such as via subscription, via the Internet, and so forth. However, timed text features may not be readily available for translation into any universal language. Accordingly, a non-English speaker receiving digital content (e.g., live streaming and/or “on demand”) may be unable to utilize captions or subtitles in their native language to consume the digital content. Accordingly, it may be beneficial to provide for systems and methods for creating, managing, and delivering universal language translations of closed captions for digital content.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In one embodiment, a method is provided. The method includes using a processor to receive identification information and a desired language. The identification information is utilized to uniquely identify a text file from a database, where the text file includes a first set of captions associated with digital content. The method includes using a processor to translate the first set of captions of the text file into the desired language utilizing a machine translation service and at least one human translator. The method includes using a processor to generate a translated text file comprising a second set of captions in the desired language and output the translated text file to a media viewing device for synchronous display with the digital content.

In a second embodiment, a system is provided. The system includes a cloud-based translation system with a memory and processor. The processor is configured to receive identification information and a desired language. The identification information is utilized to uniquely identify a text file from a database. The text file includes a first set of captions associated with digital content. The processor is also configured to translate the first set of captions of the text file into the desired language utilizing a cloud-based translator platform. The cloud-based translator platform is configured to provide access to one or more translation jobs to a plurality of human translators and generate a translated text file comprising a second set of captions in the desired language.

In a third embodiment, a tangible, non-transitory, computer-readable medium configured to store instructions executable by a processor of a computing device is provided. The instructions, when executed by a processor, are configured to receive identification information and a desired language. The identification information is utilized to uniquely identify a text file from a database, and the text file includes a first set of captions associated with digital content. The instructions, when executed by a processor, are configured to translate the first set of captions of the text file into the desired language utilizing a machine translation service and at least one human translator. Further, the instructions, when executed by a processor, are configured to generate a translated text file comprising a second set of captions in the desired language and output the translated text file to a media viewing device for synchronous display with the digital content.

### DRAWINGS

These and other features, aspects, and advantages of the present disclosure will become better understood when the following detailed description is read with reference to the accompanying drawings in which like characters represent like parts throughout the drawings, wherein:

FIG. 1 is a diagrammatical representation of an exemplary translation system that utilizes a cloud services system to deliver a translated closed caption (CC) text file to a media viewing device;

FIG. 2 is a diagrammatical representation of an exemplary translation system that utilizes a translator platform and the cloud services system of FIG. 1 to deliver a corrected translated CC text file to a media viewing device;

FIG. 3 is an illustration of a user utilizing the exemplary translation system of FIG. 2 to flag one or more portions of translated text;

FIG. 4 is a flowchart of a process for delivering a corrected translated CC text file to a media viewing device based on one or more corrections received from a user;

FIG. 5 is a block diagram of a translator platform utilized with the exemplary translation system of FIG. 2; and

FIG. 6 is an illustration of a user experience with a media viewing device utilized within the exemplary translation system of FIG. 1; and

FIG. 7 is a diagrammatical representation of the exemplary translation system of FIG. 1 that includes a supplemental content system.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. It should be noted that the term “multimedia” and “media” may be used interchangeably herein.

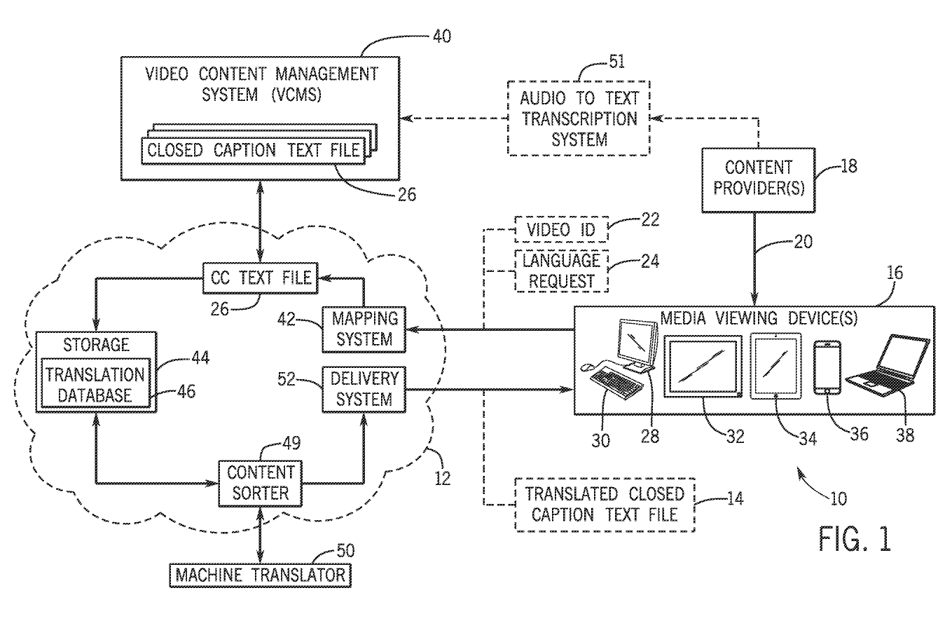

Turning to the drawings, FIG. 1 is a diagrammatical representation of an exemplary translation system 10 that utilizes a cloud services system 12 to deliver a translated closed caption (CC) text file 14 to a media viewing device 16, in accordance with aspects of the present embodiments. One or more content providers 18 may provide the media viewing devices 16 with digital content 20. In particular, in certain embodiments, the digital content 20 received from the content providers 18 may include identification information (e.g., video identification (ID) information 22) that may be utilized by the translation system 10 to identify and retrieve a corresponding closed caption (CC) text file 24. Further, in certain embodiments, the media viewing device 16 (or a user of the media viewing device 16) may provide a language request 24. The cloud services system 12 may utilize the identified CC text file 26 and the language request 24 to translate the text of the CC text file 26 into the indicated language, as further described in detail below. In this manner, the cloud services system 12 may be configured to provide the media viewing device 16 with the translated CC text file 14 for media consumption, as further described in detail below.

The content providers 18 may include television broadcast companies, cable providers, satellite programming providers, Internet-based content providers, radio stations, or any other providers of digital content. A range of technologies may be used for delivering the digital content to the media viewing devices 16. For example, the Internet, broadcast technologies, and wired or wireless proprietary networks, such as cable and satellite technologies, may be utilized to transmit the digital content. In certain embodiments, the digital content may be distributed or received as distributed as package media content, such as CDs, Blu-ray discs, DVDs, or other optically-readable media. In certain embodiments, the content provider 18 may include cloud services, which may assist in the storage and distribution of the digital content. For example, the content provider 18 associated with cloud services may include a wide variety of content that is ready for viewer retrieval and consumption.

In certain embodiments, the media viewing devices 16 may be provided in homes, business, automobiles, cinemas, public displays or venues. In some situations, the media viewing device 16 is a conventional television set 28 associated with a processing system, such as a cable, satellite, or set-top box 30. As will be appreciated by those skilled in the art, the set-top box 30 may serve to receive and decode the digital content 20 and provide audio and visual signals to the television monitor and speakers for playback. In certain embodiments, the media viewing device 16 may be an Internet-ready television set 32 that is adapted to receive, retrieve, and/or process the digital content 20. In both of these scenarios, various supplemental devices, including modems, routers, streaming media devices, computers, and so forth may be associated with the sets to provide enhanced functionality (these devices are not separately illustrated in the figure). In addition, hand-held computing devices 34 (e.g., tablets, hand-held computers, hand-held media players, etc.), smartphones 36, or personal computing devices 38 (e.g., computers, laptops, etc.) may be utilized to receive, retrieve, decode, play back, or store the digital content 20. In certain situations, the media viewing devices 16 may be adapted for receipt and playback of content in real time or near-real time as the digital content 20 is distributed. However, where storage and time-shifting techniques are utilized, timing is much more flexible. Where Internet distribution and other individualized content demand and receipt technologies are utilized, the digital content 20 may be requested, distributed and played back in a highly individualized manner.

The media viewing device 16 may provide identification information and a language request 24 to the cloud services system 12. As noted above, the digital content 20 received from the content providers 18 may include identification information for identifying one or more components of the digital content 20. For example, the identification information may include video ID information 22 that identifies the digital content 20, as well as other forms of content that may be associated with the digital content 20. For example, the cloud services system 12 may utilize the video ID 22 to access and retrieve the CC text file 26 associated with the digital content 20. A plurality of CC text files 26 may be stored within a video content management system (VCMS) 40. Specifically, the CC text files 26 may be directly associated with the digital content 20, and when identified, the VCMS 40 may be configured to provide the CC text file 26 to the cloud services system 12 for subsequent processing.

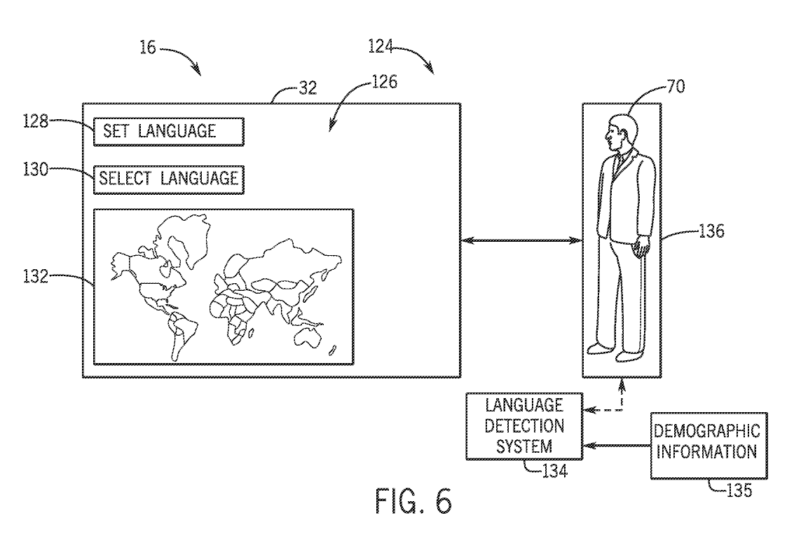

Further, in certain embodiments, the media viewing device 16 may provide the language request 24 to the cloud services 12. In certain embodiments, the language request 24 may be provided via user input to the media viewing device 16, while in other embodiments, the language request 24 may be a pre-set language stored within the media viewing device 16. Additionally, in certain embodiments, a language detection system associated with the translation system 10 and/or the media viewing device 16 may be utilized to automatically identify the language or may be utilized to automatically provide one or more language suggestions for the user. These and other embodiments are further described with respect to FIG. 6. In particular, the language request 24 may be indicative of the language that would enable the user to enjoy and consume the digital content 20. For example, a non-English speaker receiving digital content 20 may be unable to utilize captions or subtitles in their native language to consume the digital content 20. In such situations, the language request 24 provided by the non-English speaker may be their native language.

In certain embodiments, a mapping system 42 of the cloud services system 12 may be configured to receive the video ID 22 and the language request 24 provided by the media viewing device 16. In certain embodiments, the mapping system 42 may utilize the video ID 22 to access and retrieve the CC text file 26 from the VCMS 40. Specifically, the CC text file 26 may correspond to the audio and/or video components of the digital content 20. The CC text file 26 may be provided in one or more different formats or standards adopted by one or more organizations in the industry (e.g., World Wide Web Consortium (W3C), Society or Motion Picture and Television Engineers (SMPTE), and others). For example, the format of the CC text file 26 may be a Timed Text Markup Language (TTML), a Web Video Text Tracks (WebVTT), a SMPTE-Timed Text (SMPTE-TT), among others. In particular, the mapping system 42 may be configured to convert or map the CC text file 26 such that it may be easily translated or stored. For example, in certain embodiments, the mapping system 42 may organize the CC text file 26 into lines and associated text, such that the original format of the CC text file 26 is adapted into a format suitable for translation services.

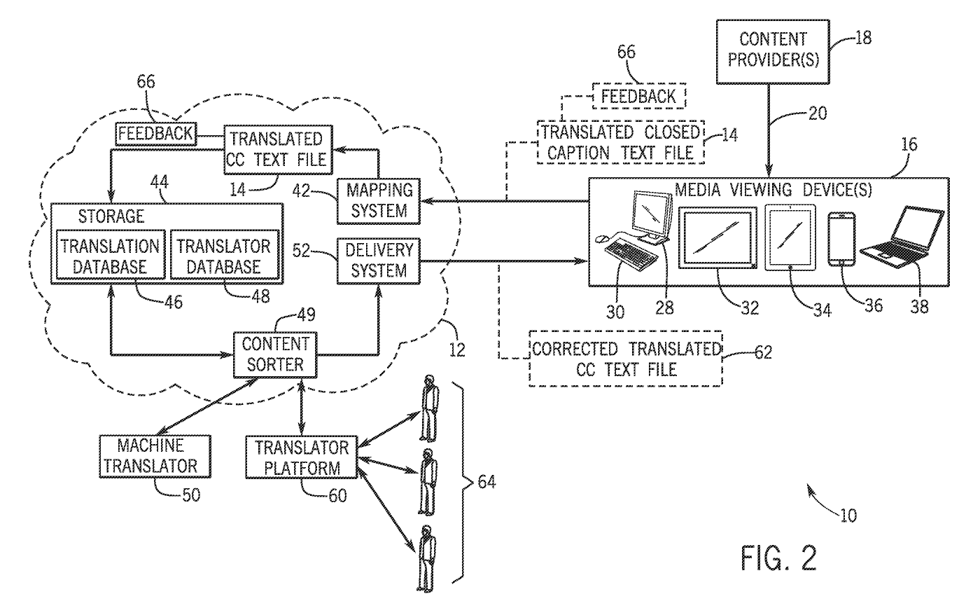

In certain embodiments, the CC text file 26 may be stored within a storage 44 of the cloud services system 12. In certain embodiments, the storage 44 may include a translation database 46 and a translator database 48 (as illustrated and described with respect to FIG. 2). The translation database 46 may be configured to store both CC text files 26 accessed and retrieved from the VCMS 40, as well as CC text files 26 that have been translated into one or more different languages, as further described below. Furthermore, in certain embodiments, the VCMS 40 may be configured to store other types of CC text files 26, such as CC text files 26 that include errors identified and marked by a user, as further described with respect to FIG. 2. Further, in certain embodiments, the translation database 46 may be configured to store translated CC text files 14 that include one or more errors identified or marked by a user, as further described with respect to FIG. 2. Accordingly, the translation database 46 may include one or more iterations of translations for the same CC text file 26. For example, after an initial translation (which may be stored within the translation database 46), one or more subsequent translations of the same CC text file 26 may also be stored within the translation database 46. In certain embodiments, the one or more subsequent translations may be translations of the same CC text file 26 into different languages. Further, in certain embodiments, the one or more subsequent translations may be different versions of the CC text file 26 in same language, different versions of the CC text file 26 provided by different translators, the CC text file 26 that incorporate one or more flags from the users or incorporate one or more corrections from the translators, etc.

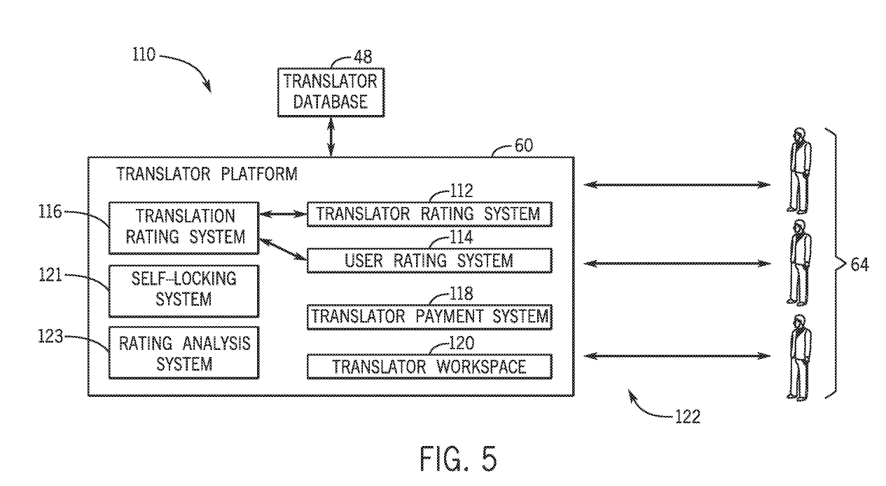

In certain embodiments, a content sorter 49 of the cloud services system 12 may be utilized to sort through the one or more different versions of the CC text file 26. For example, in certain embodiments, the content sorter 49 may identify that the CC text file 26 has never been translated into the requested language, and may provide the CC text file 26 to a machine translator 50 for translation into the requested language. Similarly, the content sorter 49 may identify that the CC text file 26 has been previously translated in the requested language and stored within the translation database 46. Accordingly, in such situations, the content sorter 49 may be configured to provide the translated CC text file 14 to a delivery system 52 for delivery to the media viewing device 16. In certain embodiments, the content sorter 49 may access the translation database 46 and find one or more different versions of the CC text file 26 in the requested language, such as versions that include poor translations, versions that include or more flags provided by users, and/or versions that have a low rating. Accordingly, in such situations, the content sorter 49 may evaluate the different versions of the CC text file 26 to deliver an identified version or determine whether a new translation is needed from the machine translator 50 and/or from one or more human translators (as illustrated and described with respect to FIGS. 2 and 5).

In certain embodiments, the machine translator 50, which may be associated with the cloud services system 12 and/or may be accessed by the cloud services system 12, may be utilized to translate the CC text file 26 into the translated CC text file 14. In certain embodiments, the machine translator 50 may be a machine translation service that translates the text of the CC text file 26 to the requested language 24. The machine translator 50 may be configured to translate to and from a variety of languages, such as, but not limited to, English, Spanish, Chinese (simplified or traditional), Dutch, French, German, Greek, Hindi, Italian, Korean, Japanese, Portuguese, Russian, Telugu, Thai, Turkish, or any other language. In certain situations, the machine translator 50 may translate the entire CC text file 26, while in other situations, the machine translator 50 may translate one or more portions of the CC text file 26. The one or more portions translated by the machine translator 50 may be portions that are identified by the content sorter 49, such as portions of poor translation or portions that include flags from previous translations.

Further, upon receiving the translated material, the content sorter 49 may be configured to generate the translated CC text file 14 by aggregating one or more different versions of the CC text files 26 or by combining one or more newly translated portions with a previously translated CC text file 14. In certain embodiments, the content sorter 49 may be configured to provide the translated CC text file 14 to the delivery system 52, as noted above. The delivery system 52 may deliver the translated CC text file 14 to the media viewing device 16, such that the translated CC text file 14 is displayed synchronously with the digital content 20 on the media viewing device 16.

In certain embodiments, one or more media viewing devices 16 may be utilized together to perform one or more of the functions described above. For example, while viewing the digital content 20 on a first media viewing device 16 (e.g., the television set 28), the user may utilize a second media viewing device 16 (e.g., smartphone 36 or hand-held computer 34) to receive and view the translated CC text file 14. Further, in certain embodiments, the second media viewing device 16 may be configured to listen and use fingerprinting techniques to identify the video and the user's location within the video, and send the information to the cloud services system 12 for translation services. In certain embodiments, the second media viewing device 16 may read the translated captions out loud to the user.

FIG. 2 is a diagrammatical representation of an exemplary translation system 10 that utilizes a translator platform 60 and the cloud services system 12 of FIG. 1 to deliver a corrected translated CC text file 62 to a media viewing device 16, in accordance with aspects of the present embodiments. As noted above with respect to FIG. 1, in certain embodiments, a machine translator 50 may be utilized to translate the CC text file 26 into a language desired by the user, and the translated CC text file 14 may be provided to the media viewing device 16. In the illustrated embodiment, a translator platform 60 may be associated with one or more human translators 64 and may be utilized to translate the CC text file 26 into the language desired by the user, as further described in detail below.

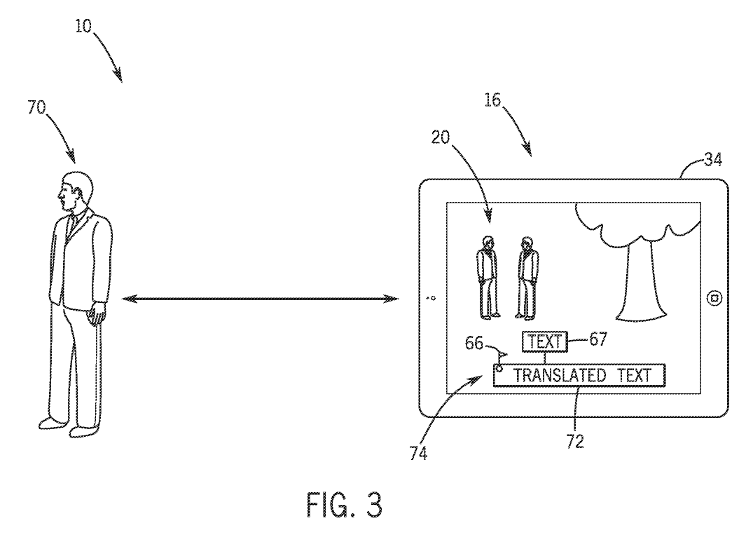

In particular, in certain embodiments, a user viewing the translated text (from the translated CC text file 14) synchronously with the digital content 20 may utilize one or more inputs of the media viewing device 16 to insert one or more flags 66 within the translated text, as further described in detail with respect to FIG. 3. Specifically, the user may utilize the flags 66 to indicate portions of the translated text that are poorly and/or improperly translated. In certain embodiments, the translated CC text file 14 with the one or more flags 66 may be provided to the cloud services system 12 and stored within the translation database 46 and/or the translator database 48. Further, in certain embodiments, the cloud services system 12 may utilize the machine translator 50 and/or the translator platform 60 to re-translate these portions of the translated CC text file 14, as further described in detail below.

Indeed, in certain situations, a machine translation may not provide an accurate and/or a nuanced translation of text, thereby resulting in a poor viewing experience for the user. Accordingly, certain aspects of the present embodiments include a translator platform 60 that is associated with one or more human translators 64. In certain embodiments, the translator platform 60 may be a component of the cloud services system 12. Specifically, the human translators 64 may access the translator database 48 via the content sorter 49, and may retrieve the translated CC text file 14 and any corresponding flags 66 marked by a user. The human translators 64 may be configured to manually re-translate any text material of the translated CC text file 14 that is associated with the flags 66. Further, the human translators 64 may upload the corrected translated material to the content sorter 49. As noted above, in certain embodiments, the content sorter 49 may be configured to generate the corrected translated CC text file 62 by aggregating the one or more portions of the re-translated material with the previously translated material. Further, in certain embodiments, the content sorter 49 may store the corrected translated CC text file 62 within the translation database 46 and/or the translator database 48 for a subsequent user and/or may provide the corrected translated CC text file 62 to the delivery system 52 for delivery to the media viewing device 16.

It should be noted that in certain embodiments, the translation system 10 may utilize the one or more human translators 64 to generate the translated CC test file 14. That is to say, rather than utilize the machine translator 50 to generate the translated CC text file 14, the cloud services system 12 may retrieve the CC text file 26 from the VCMS 40, and the content sorter 49 may utilize the one or more human translators 64 to translate the material and generate the translated CC text file 14. Furthermore, the delivery system 52 may deliver the translated CC text file 14 to the media viewing device 16, where the user (such as the user who requested the translation and/or a different user who subsequently requests the same translation) may have the opportunity to insert one or more flags 66 within the translated CC text file 14 while viewing the digital content 20.

In certain embodiments, the translated CC text file 14 and the associated flags 66 are provided to the cloud services system 12 and stored within the translation database 46 and/or the translator database 48 for corrections (e.g. re-translations). Further, a different user may subsequently request the same translation before the cloud services system 12 has an opportunity to utilize the machine translator 50 and/or the translator platform 60 for the corrections. In such embodiments, the cloud services system 12 may provide the translated CC text file 14 along with the one or more flags 66 inserted by the previous user to the new, different user. Alternatively, in such embodiments, the cloud services system 12 may provide only the translated CC text file 14.

FIG. 3 is an illustration of a user 70 utilizing the exemplary translation system 10 of FIG. 2 to insert one or more flags 66 within the displayed translated text 72 that is output on the media viewing device 16. Specifically, in the illustrated embodiment, the user 70 may be viewing the digital content 20 on a display 74 of the hand-held computing device 34 (e.g., tablets, hand-held computers, hand-held media players, etc.). In particular, the media viewing device 16 may be configured to receive and output the text associated with the translated CC text file 14, thereby outputting the displayed translated text 72 on the display 74. As noted above, the displayed translated text 72 may be synchronous with the digital content 20. However, in certain situations, the displayed translated text 72 may not be synchronous with the digital content 20, may be improperly translated, may be a subpar or poor translation, may include the wrong language, may be omitting a language nuance, or so forth. Accordingly, in these situations, the user 70 may be configured to insert the one or more flags 66 on the displayed translated text 72.

In certain embodiments, the user 70 may insert flags 66 by tapping or selecting (such as with a finger or a cursor) the portion of the displayed translated text 72 that needs the correction. The selected portion of the displayed translated text 72 may change color to indicate to the user 70 that a selection was made. In some situations, a symbol (e.g., a flag, a dot, a line, an underline, italics, etc.) may appear on the display 74 to further indicate to the user 70 the portion of the text that is selected. Further, in certain embodiments, various colors or indicia may be utilized to indicate the status of the displayed translated text 72. For example, different colors or symbols may be utilized to indicate whether the displayed translated text 72 was machine translated or human translated. Further still, different colors or symbols may be utilized to indicate whether a previous flag was corrected or whether the previous flag was not corrected. In addition, in some situations, the user 70 may flag a previously flagged portion of the displayed translated text 72 that has not yet been corrected. In such situations, the translation system 10 may be configured to prioritize the digital content 20 and the corresponding translated CC text files 14 that have multiple flags or errors.

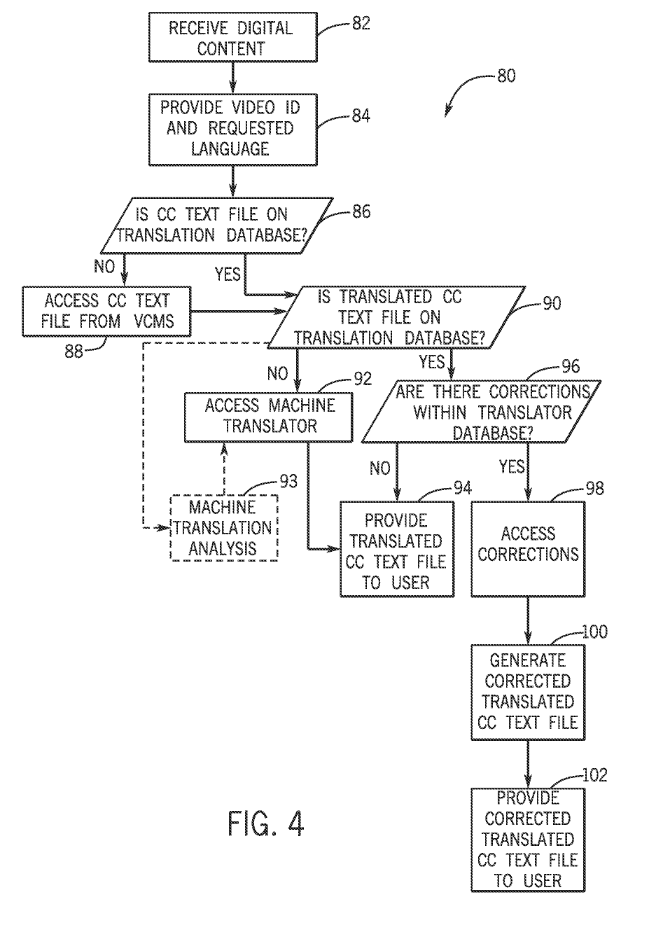

FIG. 4 is a flowchart of a process for delivering a corrected translated CC text file 62 to the media viewing device 16 based on one or more flags 66 received from the user 70, in accordance with aspects of the present embodiments. In particular, the method 80 begins with the media viewing device 16 receiving digital content 20 from the one or more content providers 18 (block 82). Further, based on the digital content 20 received, the user consuming the digital content 20 may request a captions translation for the audio and/or video content and select or set a desired language. Specifically, the identification information for the digital content (e.g., the video ID 22) and the language request 24 may be provided to the cloud services system 12 from the media viewing device 12 (block 84).

The method 80 further includes determining whether the CC text file 26 associated with the video ID 22 and the digital content 20 is available within the translation database 46 (block 86). In certain situations, a different and previous user may have requested a translation in the same language for the same video ID 22. Accordingly, the CC text file 26 may have been previously accessed and stored within the translation database 46. If the CC text file 26 is not within the translation database 46, the method 80 further includes accessing and retrieving the CC text file 26 from the VCMS 40 (block 88).

Alternatively, if the CC text file 26 is within the translation database 46, the method 80 further includes determining whether the translated CC text file is stored within the translation database 46 (block 90). For example, in certain situations, the CC text file 26 may have been previously translated (e.g., via the machine translator 50 and/or the translator platform 60) and stored within the translation database 46). Accordingly, if the translated CC text file 14 is not on the translation database 46, the method 80 further includes accessing the machine translator 50 to translate the CC text file 26 (block 92). It should be noted that in certain embodiments, the cloud services system 12 may access the translator platform 60 (and one or more human translators 64) to translate the CC test file 26. Once the CC text file 26 is translated, the method 80 includes providing the translated CC text file 14 to the user who requested the translation (block 94).

Alternatively, if the translated CC text file 14 is on the translation database 46, the method 80 further includes checking the translator database 48 to determine if any previously identified (e.g., flagged) errors were corrected by one or more human translators 64 (block 96). It should be noted that in certain embodiments, a different machine translator 50 may be utilized to correct the marked errors in lieu of the human translators 64. Further, the method 80 includes accessing the corrections (block 98) to generate the corrected translated CC text file 62 (block 100) and delivering the corrected translated CC text file 62 to the user who requested the translation (block 102).

FIG. 5 is a block diagram of the translator platform 60 utilized with the exemplary translation system of FIG. 2, in accordance with aspects of the present embodiments. Specifically, as noted above, the translator platform 60 may be a platform to aggregate one or more human translators 64. In particular, the translator platform 60 may be accessed by a plurality of human translators 64 from different geographical origins and language backgrounds. Specifically, the human translators 64 may access the translator database 48 of the cloud services system 12 via the translator platform 60 to select one or more translation jobs available. In certain embodiments, the translation job may be to re-translate one or more portions of the translated CC text file 14 that have been flagged by a user as incorrect. Further, in certain embodiments, the translation job may be a first time translation of the CC text file 26, and the human translator 64 may translate the entire CC text file 26, rather one or more portions of the file.

In certain embodiments, the translator platform 60 may include various features to enhance the efficiency of the human translators 64. Specifically, the translator platform 60 may include a translator rating system 112, a user rating system 114, a translation rating system 116 that is associated with the translator rating system 112 and the user rating system 114, a translator payment system 118, and a translator workspace 120.

The translator rating system 112 may be utilized in combination with the translation rating system 116 to evaluate the human translator 64 and the quality of work contributed by the human translator 64. For example, the translation rating system 116 may be utilized to evaluate the quality of the translations accessed and completed by the human translators 64. In certain embodiments, the quality of the translations may be determined based on one or more quality parameters, such as, for example, a number of flags 66 inserted by a user into the translated CC text file 14 and/or the corrected translated CC text file 62, a completion time, a location of the human translator 64 with regard to the language being translated, or any combination thereof. In certain embodiments, the human translator 64 may start with a default rating, and the default rating may increase or decrease based on the translation rating system 116. Likewise, in certain embodiments, each user 70 may start with a default rating, and the rating may increase or decrease based on the quality of the corrections provided by the user.

In certain embodiments, the translator platform 60 may include a translator payment system 118 that may be utilized by the human translators 64 to receive payment for one or more completed translation jobs. For example, the translator payment system 118 may have access to the translator's workspace 120, and may be configured to pay the human translator 64 based on the number of words translated and/or based on a number of jobs completed. In certain embodiments, a human translator 64 that has a higher rating may receive a higher payment for the translation services.

Further, the translator platform 60 may include the translator workspace 120. The translator workspace 120 may include one or more resources that the human translator 64 may access via wired/wireless communication channels 122 or the Internet. These resources, for example, may be utilized to view the digital content 20 during the translation process. Further, the workspace 120 may include one or more video or audio resources that may be beneficial during the translation process. The workspace 120 may include a history of the translation jobs completed, payment information, personal information related to the human translator 64 (e.g., identification information, location, language expertise, etc.), among other information. In certain embodiments, the translator workspace 120 may include communication functionalities that allow one or more human translators 64 to communicate between each other and/or collaborate as a group.

FIG. 6 is an illustration of a user experience 124 with the media viewing device 16 utilized within the exemplary translation system 10 of FIG. 1. In the illustrated embodiment, the media viewing device 16 may be an Internet-ready television set 32 that is adapted to receive, retrieve, and/or process the digital content 20. The Internet-ready television set 32 may include a touch screen display 126 that may be accessed by the user 70 and/or may include a remote (not illustrated) that may be utilized to manipulate and select features on the display. As noted above, in certain embodiments, the user 70 may provide the language request 24, which may be the desired language of the captions for the digital content 20. In certain embodiments, the user may manually set the language (reference number 128), such that the media viewing device 16 includes a pre-set language that is stored on the device. Further, in certain embodiments, the media viewing device 16 may be provided by the user 70 via one or more inputs, such as a drop-down menu 130 that include one or more different language options. Additionally, in certain embodiments, the one or more inputs may include a world or regional map 132, and the user 70 may select the location and/or language by selecting an associated location on the map 132.

Additionally, in certain embodiments, a language detection system 134 associated with the media viewing device 16 may be utilized to automatically identify the language or may be utilized to automatically provide one or more language suggestions for the user. For example, the language detection system 134 may utilize a geographical location 136 of the user 70 to automatically detect a language option and/or automatically provide one or more language suggestions. For example, the user 70 may be a native Russian speaker, and may be located within Russia. Accordingly, the language detection system 134 may automatically detect the location of the user and set the language (reference number 120) to Russian for future translations. As a further example, the user 70 may be located in Miami, and the language detection system 134 may automatically detect the location of the user 70 to provide one or more language suggestion (e.g., English, Spanish, etc.).

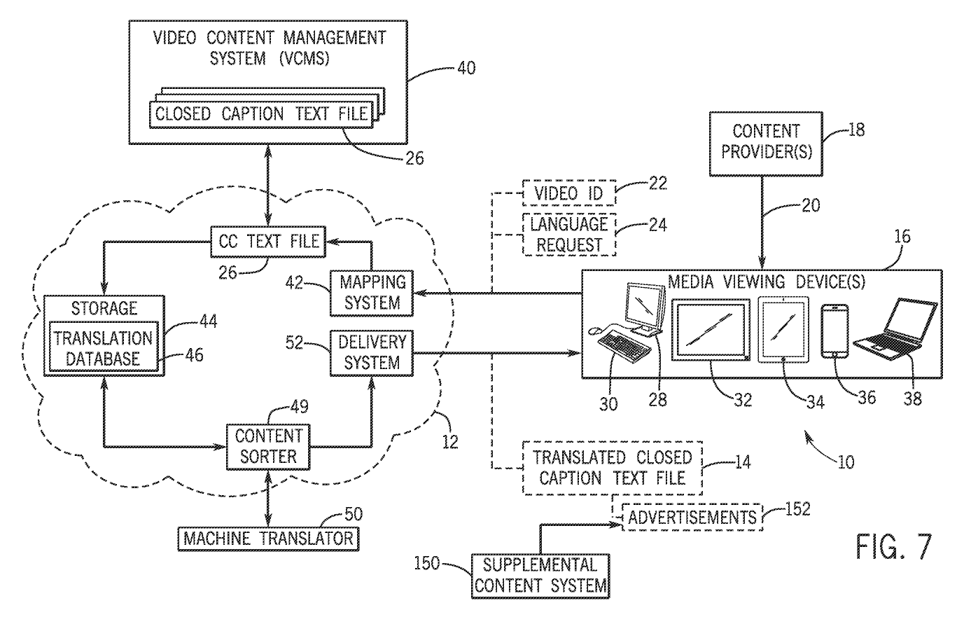

FIG. 7 is a diagrammatical representation of the exemplary translation system 10 of FIG. 1 that includes a supplemental content system 150. The supplemental content system 150 may be configured to provide one or more advertisements 152 as supplemental content to the translated CC text file 14. Specifically, one or more advertisements 152 may be displayed on the media viewing device 16 along with the displayed translated test 72 and the digital content 20. In certain embodiments, the supplemental content system 150 may utilize information from the users 70 (e.g., geographical information of the user, a language selection indicated by the user, etc.) to determine one or more targeted advertisements 152.

1. A method, comprising:
using a processor configured to:
receive identification information and a desired language, wherein the identification information is utilized to uniquely identify a text file from a database, wherein the text file comprises a first set of captions associated with digital content;
translate the first set of captions of the text file into the desired language utilizing a machine translation service and at least one human translator;
generate a translated text file comprising a second set of captions in the desired language; and
output the translated text file to a media viewing device for synchronous display with the digital content.

2. The method of claim 1, wherein the processor is associated with a cloud services system.

3. The method of claim 1, wherein the processor is configured to receive the identification information and the desired language from the media viewing device.

4. The method of claim 1, wherein the at least one human translator manually translates one or more portions of the first set of captions into the desired language.

5. The method of claim 1, wherein the at least one human translator accesses the first set of captions of the text file via a translator platform.

6. The method of claim 5, wherein the translator platform comprises a rating system to evaluate the quality of the translation services provided by the at least one human translator.

7. The method of claim 1, wherein the processor is configured to receive the translated text file from the media viewing device, wherein the received translated text file comprises one or more flags marked by a user.

8. The method of claim 7, wherein the one or more flags are indicative of errors in translation identified by the user.

9. The method of claim 8, wherein the at least one human translator accesses the received translated text file and the one or more flags to correct the errors.

10. The method of claim 9, wherein the processor is configured to generate a corrected translated text file comprising a third set of captions in the desired language, wherein the third set of captions include translation corrections made based on one or more identified errors.

11. The method of claim 10, wherein the processor is configured to output the corrected translated text file to the media viewing device for synchronous display with the digital content.

12. A system, comprising:
a cloud-based translation system comprising a memory and processor configured to:
receive identification information and a desired language, wherein the identification information is utilized to uniquely identify a text file from a database, wherein the text file comprises a first set of captions associated with digital content;
translate the first set of captions of the text file into the desired language utilizing a cloud-based translator platform, wherein the cloud-based translator platform is configured to provide access to one or more translation jobs to a plurality of human translators; and
generate a translated text file comprising a second set of captions in the desired language.

13. The system of claim 12, wherein the cloud-based translation system is communicatively coupled to the media viewing device.

14. The system of claim 13, wherein the cloud-based translation system is configured to output the translated text file to the media viewing device for synchronous display with the digital content.

15. The system of claim 12, comprising a machine translator configured to translate the first set of captions of the text file into the desired language.

16. The system of claim 12, comprising a video content management system configured to store a plurality of text files.

17. A tangible, non-transitory computer-readable medium storing computer instructions thereon, the computer instructions, when executed by a processor, configured to:
receive identification information and a desired language, wherein the identification information is utilized to uniquely identify a text file from a database, wherein the text file comprises a first set of captions associated with digital content;
translate the first set of captions of the text file into the desired language utilizing a machine translation service and at least one human translator;
generate a translated text file comprising a second set of captions in the desired language; and
output the translated text file to a media viewing device for synchronous display with the digital content.

18. The computer-readable medium of claim 17, wherein the instructions instruct a computer to receive the translated text file from the media viewing device, and wherein the received translated text file comprises one or more flags marked by a user.

19. The computer-readable medium of claim 18, wherein the one or more flags are indicative of errors in translation identified by the user.

20. The computer-readable medium of claim 17, wherein the instructions instruct a computer to generate a corrected translated text file comprising a third set of captions in the desired language, wherein the third set of captions include translation corrections made by the at least one human translator based on one or more identified errors.
